(19) United States
(12) Patent Application Publication
(10) Pub. No.: US 2017/0050890 A1
(43) Pub. Date: Feb. 23, 2017

(54) Advanced Mirrors Utilizing Polymer-Derived-Ceramic Mirror Substrates

(71) Applicant: Dynamic Material Systems, LLC, Oviedo, FL (US)

(72) Inventors: Arnold Hill, Orlando, FL (US); William Easter, Chuluota, FL (US)

(21) Appl. No.: 15/349,480

(22) Filed: Nov. 11, 2016

Related U.S. Application Data
(63) Continuation-in-part of application No. 15/274,899, filed on Sep. 23, 2016.
Application No. 15/274,899 is a continuation-in-part of application No. 14/858,096, filed on Sep. 18, 2015.
Application No. 14/858,096 is a continuation-in-part of application No. 14/598,658, filed on Jan. 16, 2015, now Pat. No. 9,434,653.
Application No. 14/598,658 is a division of application No. 13/775,594, filed on Feb. 25, 2013, now Pat. No. 8,961,840.
(60) Provisional application No. 62/253,951, filed on Nov. 11, 2015.
(60) Provisional application No. 62/232,033, filed on Sep. 24, 2015.
(60) Provisional application No. 62/053,479, filed on Sep. 22, 2014.
(60) Provisional application No. 61/606,007, filed on Mar. 2, 2012.

(51) Int. Cl. C04B 41/88; G02B 5/08; G11B 5/84; G02B 5/10; G02B 19/00; B29D 11/00; G02B 1/04

(52) U.S. Cl. CPC C04B 41/88; B29D 11/00596; B29D 11/00865; G02B 5/0808; G02B 1/04; G02B 5/10; G02B 19/0023; G11B 5/84; C04B 2235/3895

(57) ABSTRACT

Methods, systems, and processes are used to prepare strong, durable, light-weight, mirrors, aspheric mirrors, disk drives and component parts using polymer-derived ceramics (PDCs), such as silicon oxycarbide (SioC) as a substrate for the mirror blank or disk drive. Very high performance mirrors and machine components are produced at much lower costs; thus increasing their usage in applications as varied as extra-terrestrial space applications to machine vision used by robots to stationary terrestrial mirrors and machines.

### CROSS REFERENCE TO RELATED APPLICATIONS

This application claims the benefit of priority to U.S. Provisional Patent Application Ser. No. 62/253,951, filed Nov. 11, 2015, and this application is a Continuation-In-Part of U.S. patent application Ser. No. 15/274,899, filed Sep. 23, 2016, which claims the benefit of priority to U.S. Provisional Patent Application Ser. No. 62/232,033, filed Sep. 24, 2015, which is a Continuation-In-Part of U.S. patent application Ser. No. 14/858,096, filed Sep. 18, 2015, which claims the benefit of priority to U.S. Provisional Patent Application Ser. No. 62/053,479 filed Sep. 22, 2014, which is a Continuation-In-Part of U.S. patent application Ser. No. 14/598,658, filed Jan. 16, 2015, now U.S. Pat. No. 9,434,653, which is a Divisional of U.S. patent application Ser. No. 13/775,594, filed Feb. 25, 2013, now U.S. Pat. No. 8,961,840, which claims the benefit of priority to U.S. Provisional Patent Application Ser. No. 61/606,007, filed Mar. 2, 2012. The entire disclosure of each application listed in this paragraph is incorporated herein by specific reference thereto.

### FIELD OF THE INVENTION

This invention relates to methods, processes and systems for producing and manufacturing high performance mirrors from polymer-derived ceramic composites.

### BACKGROUND AND PRIOR ART

Mirrors are commonly used optical elements by scientists and researchers. The quality, reflectivity, laser damage resistance, performance, coating durability, reliability, ability to withstand hot and cold temperatures are key to successful use of mirrors on earth and outside of the earth's atmosphere—in space.

Currently high performance mirrors are made primarily with glass or ceramic substrates. Glass has the advantage of being easier to polish while ceramics, typically silicon carbide (SiC), have better mechanical properties which makes ceramic materials more attractive in terms of mirror applications associated with both higher temperature performance and higher mechanical performance.

In either case, in the processing of both glass and ceramic mirror blanks, there are high-temperature, high energy process steps needed to produce the mirror blanks. These processes use a lot of energy and have long manufacturing intervals. In the case of Zerodur® extremely low expansion glass ceramic or Hexoloy® a pressureless sintered form of alpha silicon carbide (SiC), the manufacturing lead-times are typically several weeks or even months long. Zerodur is a registered trademark of Schott AG, Mainz, Germany. Hexoloy is a registered trademark of Saint-Gobain, Courbevoie, France.

A primary reference for making a silicon carbide (SiC) ceramic mirror is, “Overview of the Production of Sintered SiC Optics and Optical Sub-assemblies,” S. Williams, CoorsTek; P. Deny, BOOSTEC Industries (France) [5868-04] published in Optical Materials and Structures Technologies II (OE1402), SPIE Optics and Photonics 2005, San Diego, Calif.

The following references provide information for making high performance glass mirrors. “ZERODUR 8 m Mirror for Space Telescope,” Hartman et al (Scott AG) Proceedings of SPIE Volume 7731, 77313Y (Aug. 11, 2010).

“Mirrors for solar telescopes made from ZERODUR glass ceramic,” Dohring et al (SCHOTT AG) Proceedings of SPIE Vol 6689 66890X-(Sep. 20, 2007); http://dx.doi.org/10.1117/12.733728.

Applications for the mirror technology in the present patent application include using the mirror as an aspheric beam steering mirror such as shown and described in U.S. Pat. No. 9,348,126 to Cook dated May 24, 2016 which is incorporated herein by reference. Further applications of this mirror technology includes the aspheric mirror projection-type image displaying apparatus shown and described in U.S. Pat. No. 8,192,032 to Takahashi et al. dated Jun. 5, 2012 and incorporated herein by reference.

The asymmetric shapes of aspheric and free form mirror components make mirror manufacturing complex, difficult, and time consuming with traditional techniques which are typically planar and symmetrical. The shaping of plastic intermediate structures by molding, 3D printing/additive manufacturing and/or machining is much simpler and less expensive than shaping typical glass or ceramic components.

It is known that in order to decrease the weight of the highest performance mirrors, extensive grinding and/or machining to the back of the mirror surface is required. The extensive high energy, long time interval processes of making glass or ceramic mirrors is both costly and time consuming. Therefore, there is need for a more energy efficient, timelier way to produce high performance mirrors, including aspheric mirrors.

The present invention provides polymer-derived ceramic (PDC) materials that provide performance improvements, light-weight, and low manufacturing costs desired for high performance mirrors.

In addition to high performance mirrors, this application provides materials which can be used in direct access magnetic disk storage devices as shown and described in U.S. Pat. No. 3,503,060 to Goddard dated Mar. 24, 1970, which is incorporated herein by reference. Every computer contains a magnetic data storage disk consisting of a mirror coated with magnetic material; the mirror element can be provided by the present invention.

Magnetic data storage disks spin at very high speeds and have to start and stop quickly. These inertial forces create high stresses in the disk material. That means the disk material has to have high strength to handle the centrifugal forces and have low mass to allow for high accelerations. Also the reader heads have to be kept in close proximity to the surface of the spinning disk. That means the disks have to be very stiff so as to not deflect and make contact with the reader head. PDCs represent a material that has these properties which makes them ideal for magnetic disks for data storage.

The magnetic storage disks are made in similar fashion as a mirror, which includes being molded directly into a disk or machined from a solid block of green body material. Once the cured green body disks are pyrolyzed into ceramic they would be polished flat and coated with the same magnetic materials as used in aluminum or glass based magnetic storage disks. The mechanical properties of the ceramic disks made by this process can be increased for larger diameter, higher revolutions per minute (rpm) by increasing the density of the ceramic as needed.

The present invention provides polymer-derived ceramic materials that provide performance improvements, light-weight, and low manufacturing costs desired to replace heavy, cumbersome, components of scientific equipment, magnetic data storage disks for computers, and the like.

### SUMMARY OF THE INVENTION

A primary objective of this invention is to provide methods, systems, and processes to manufacture high performance mirrors at a lower manufacturing cost than the current state of the art.

A secondary objective of this invention is to provide methods, systems, and processes to provide a preferred embodiment of an advanced mirror utilizing Polymer-Derived Ceramic silicon oxycarbide (SiOC) with improved mirror performance.

A third objective of this invention is to provide methods, systems, and processes to prepare Polymer-Derived Ceramic silicon oxycarbide (SiOC) mirror that weighs less than a glass mirror or a silicon carbide (SiC) mirror.

A fourth objective of this invention is to provide methods, systems, and processes to prepare a Polymer-Derived Ceramic mirror substrate wherein the silicon oxycarbide (SiOC) polymer is approximately half the density of silicon carbide (SiC).

A fifth objective of this invention is to provide methods, systems, and processes to prepare a Polymer-Derived Ceramic mirror substrate with the tougher, more dense silicon carbide (SiC) polymer at lower costs due to a shorter manufacturing interval and lower temperatures than the current state of the art.

A sixth objective of this invention is to provide methods, systems, and processes to prepare polymer-derived ceramic (PDC) mirrors for applications involving transportation including space applications.

A seventh objective of this invention is to provide methods, systems, and processes to prepare polymer-derived ceramic (PDC) mirrors for terrestrial stationary mirrors, the reduction of weight will reduce the weight and cost of supporting structures for the terrestrial mirrors.

An eighth objective of this invention is to provide methods, systems, and processes to prepare polymer-derived ceramic (PDC) mirror substrates, specifically SiOC, with lower co-efficient of thermal expansion (CTE) characteristics than SiC resulting in better optical performance of the mirror as it cycles over varying temperatures.

A ninth objective of this invention is to provide methods, systems, and processes to prepare polymer-derived ceramic (PDC) mirror substrates for use in space applications.

A tenth objective of this invention is to provide methods, systems, and processes to prepare polymer-derived ceramic (PDC) mirror substrates for use in aspheric mirrors.

An eleventh objective of this invention is to provide methods, systems, and processes to prepare polymer-derived ceramic (PDC) mirror substrates for magnetic disk storage devices for computers.

A twelfth objective of this invention is to provide methods, systems, and processes to prepare polymer-derived ceramic (PDC) mirror substrates for machine vision used by robots.

Preferably, a process for producing a mirror using a polymer-derived ceramic (PDC) system includes selecting a cured polymer-derived ceramic (PDC) green body, figuring the cured green body to provide a shaped green body for optimal performance, applying a dense, non-porous, viscous layer of a PDC resin to the surface of the shaped green body, pyrolyzing the green body with the dense layer of the PDC resin to form a ceramic mirror blank, polishing the dense layer of the pyrolyzed PDC resin on the ceramic mirror blank to provide a pristine surface, and adding a metal layer to the pristine surface of the ceramic mirror blank to provide the mirror function wherein the metal layer is selected from at least one of aluminum, gold, or silver.

Preferably, the process for producing a mirror includes a cured resin green body formed from a polymer-derived ceramic (PDC) system including one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) or silicon carbide (SiC).

It is also preferred that the process for producing a mirror include a figuring step for shaping the cured green body by at least one of machining or molding to create a concave shape, an aspherical shape, or a convex shape to optimize the mirror performance. When the dense, non-porous, viscous layer of a PDC resin is added to the surface of the shaped green body, the PDC resin has a thickness of from approximately 0.5 microns to approximately 350 microns.

Preferably, a process for producing a mirror using a polymer-derived ceramic (PDC) system wherein the mirror is figured, sealed and coated, the process includes selecting a cured resin green body, shaping the cured green body to optimize mirror performance, pyrolyzing the shaped green body to form a ceramic mirror blank with a porous surface, sealing and coating the porous surface of the ceramic mirror blank to provide a smooth, level, defect-free surface, and adding a metal layer to the smooth, level, defect-free surface of the ceramic mirror blank to provide the mirror function wherein the metal layer is selected from at least one of aluminum, gold, or silver.

Preferably the process for producing the sealed and coated mirror includes a cured resin green body formed from a polymer-derived ceramic (PDC) system from one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) or silicon carbide (SiC).

It is also preferred that the shaping of the green body is performed by machining, molding, grinding, lapping and polishing to provide a precision figure to the mirror blank.

Preferably, the sealing and coating of the porous surface of the mirror blank is accomplished by adding at least one of glass, polymer resin, or silicon based sol gels to form a smooth, level, defect-free surface.

It is also preferred that the process for producing the sealed and coated mirror further include the step of adding a plurality of particles selected from metal, glass, polymer, ceramic, and mixtures thereof, to the porous surface of the ceramic mirror blank after pyrolyzing the shaped green body to form a ceramic mirror blank with a porous surface wherein the plurality of particles selected from metal, glass, polymer, ceramic and mixtures thereof form a composite material that is one of a metal-PDC composite, a glass-PDC composite, a polymer-PDC composite, a ceramic-PDC composite or combinations thereof.

Preferably a process for producing a mirror with a porous surface electromagnetic (EM) concentrator using a polymer-derived ceramic (PDC) system includes selecting a cured resin green body, shaping the cured green body to optimize mirror performance, pyrolyzing the shaped green body to form a ceramic mirror blank with a porous surface, adding a plurality of particles selected from metal, glass, polymer, ceramic, and mixtures thereof, to the porous surface of the ceramic mirror blank to alter properties of the porous ceramic mirror blank, and grinding and polishing the porous surface of the ceramic mirror blank containing the plurality of particles selected from metal, glass, polymer, ceramic, and mixtures thereof of to provide a ground and polished porous surface having pore sizes smaller than the width of the wavelength of the electro-magnetic (EM) energy so that the pore sizes do not interfere with the performance of the mirror in reflecting the EM energy.

It is also preferred that the process for producing a mirror with a porous surface include a cured resin green body formed from a polymer-derived ceramic (PDC) system that is one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) and silicon carbide (SiC). Preferably, the porous surface of the ceramic mirror blank remains unsealed.

Preferably, a process for producing an aspheric mirror using a polymer-derived ceramic (PDC) system includes selecting a plurality of partially-cured gelatinous polymer-derived ceramic (PDC) resin beads, shaping the plurality of partially-cured gelatinous PDC resin beads with a mold having a surface profile that is the topographical inverse of a selected aspheric shape, placing the mold with the aspheric shaped PDC resin beads into a heating source, pyrolyzing the aspheric shaped PDC resin beads to form an aspheric ceramic mirror blank, removing the pyrolyzed aspheric ceramic mirror from the mold, polishing the aspheric ceramic mirror blank to provide a pristine surface, and coating the polished aspheric ceramic mirror blank with a reflective material, wherein the reflective material is a metal layer selected from at least one of aluminum, gold, or silver.

Preferably, the process for producing an aspheric mirror further includes shaping the plurality of partially-cured gelatinous PDC resin beads into an aspheric shape using an additive manufacturing process then pyrolyzing the aspheric shaped PDC resin beads to form an aspheric ceramic mirror blank. The partially-cured gelatinous PDC resin beads are formed from a polymer-derived ceramic (PDC) system that is one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) and silicon carbide (SiC).

Preferably a process for producing a mirror substrate for a magnetic data storage disk includes selecting a plurality of partially-cured gelatinous polymer-derived ceramic (PDC) resin beads, placing the plurality of partially-cured gelatinous PDC resin beads in a mold, compressing the plurality of partially-cured gelatinous PDC resin beads to a thickness of approximately 1 mm to approximately 100 mm, placing the mold with compressed PDC resin beads into a heating source, pyrolyzing the plurality of partially-cured PDC resin beads to form a ceramic disk, removing the pyrolyzed ceramic disk from the mold, grinding the pyrolyzed ceramic disk to provide a pristine surface, and coating the ground disk with a magnetic material, wherein the magnetic material is selected from at least one of a cobalt-platinum alloy or an iron-platinum alloy.

It is also preferred that the partially-cured gelatinous PDC resin beads are formed from a polymer-derived ceramic (PDC) system that is one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) or silicon carbide (SiC), more preferably the partially-cured gelatinous PDC resin beads are derived from silicon oxycarbide (SiOC).

Polymer Derived Ceramics (PDCs) provide a way to make bulk ceramic and ceramic composites in temperature ranges between approximately 600° C. and approximately 1100° C. without the need for sintering of previously made ceramic particles. In most cases, PDCs will also provide a way for using a lower energy signature than the energy signature used to produce glass.

The issues with Polymer-Derived Ceramics have historically been that “the polymer to ceramic conversion occurs with gas release which typically leads to cracks or pores which make the direct conversion of a preceramic part to dense ceramic virtually unachievable unless its dimension is typically below a few hundred micrometers (as in the case of fibers, coatings, or foams.)” J. Am. Ceram. Soc. 93 [7] p. 1811 (2010).

The inventors on the present patent application have solved this problem with the previously issued U.S. Pat. No. 8,961,840 and U.S. Pat. No. 9,434,653 which are incorporated herein by reference. U.S. Pat. No. 8,961,840 is related to the present invention and solves the problem of making a direct conversion of a preceramic part (green body) to a dense ceramic without gas release that typically leads to cracks or pores. U.S. Pat. No. 9,434,653 is related because it provides for mirror components that are thicker than a few hundred microns.

In the current patent application, some of the same principles of U.S. Pat. No. 8,961,840 will be used to produce mirrors utilizing a PDC mirror blank. That mirror will be improved over the current technologies in terms of the energy used to produce the mirror as well as the ease of lightweighting the mirror. Mirror blank substrates containing complex lightweighted shapes located into the back of the mirror blank can be formed by either molding or 3D printing of the mirror blanks. Several processes of Additive Manufacturing/3D Printing of PDCs are covered by the present inventors in U.S. Provisional Patent Application Ser. No. 62/232,033 which is also incorporated herein by reference. Dense, non-porous partially-cured polymer beads are fed into a 3D printing apparatus.

As stated previously, the ease of providing a lightweighted component is a significant advantage over other glass and ceramic technologies. The same chemistries that are available with U.S. Pat. No. 8,961,840 as well as the chemistries associated with U.S. patent Ser. No. 14/858,096 for ceramic particles are applicable here.

For both glass and high performance ceramics, the PDC is much lighter. When comparing density, the density of SiOC is approximately 1.6 g/cc, roughly half the density of SiC which is approximately 3.2 g/cc. Also, when comparing the co-efficient of thermal expansion (CTE), SiOC has a CTE value approximately ⅓ of the CTE value of SiC; this results in better optical performance of the mirror as it cycles over varying temperatures. However, if the mechanical properties of the more dense SiC is desired, PDCs can be made to produce SiC at much shorter manufacturing intervals and temperatures thus reducing cost.

After the polymer-derived ceramic blank has been completed, there are several embodiments that are available to form a metallized mirror.

Further objects and advantages of this invention will be apparent from the following preferred embodiments.

### BRIEF DESCRIPTION OF THE FIGURES

FIG. 1A shows a front view of a circular PDC mirror

FIG. 1B shows a back view of a circular PDC mirror.

FIG. 2A shows a front view of a hexagonal PDC mirror.

FIG. 2B shows a back view of a hexagonal PDC mirror.

FIG. 3A is a mirror blank (Prior Art).

FIG. 3B shows the initiation of stress polishing to create a curvature in the blank. (Prior Art)

FIG. 3C shows continuation of stress polishing to create curvature on one side of the blank. (Prior Art)

FIG. 3D in an inverted view of an aspheric mirror blank wherein on side of the blank has an undulating curved surface while the opposing side is straight. (Prior Art)

FIG. 4 shows the uneven curvature of an aspheric mirror or lens. (Prior Art)

FIG. 5A is a top view of a magnetic disk for data storage.

FIG. 5B is a side view of a magnetic disk for data storage.

### DESCRIPTION OF THE PREFERRED EMBODIMENTS

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

Incorporated herein by reference are the teachings in U.S. Pat. No. 8,961,840, U.S. Pat. No. 9,434,653 and U.S. Provisional Patent Application Ser. No. 62/232,033 filed Sep. 24, 2015, regarding the manufacture of pre-ceramic polymer beads that are useful in the present invention. U.S. Pat. No. 8,961,840 provides for the manufacture of beads made from multiple different precursor resins. Each of these resins gives rise to a different ceramic material. U.S. Pat. No. 9,434,653 provides for mirror components that are thicker than a few hundred microns.

U.S. Provisional Patent Application Ser. No. 62/232,033 provides for the manufacture of a fully dense polymer derived ceramic particle with enhancement particles attached to or incorporated within the structure of the particle to provide unique sizes, compositions, mechanical and chemical properties of the preceramic polymer beads. Examples of the enhancement particles that may be inside or outside the beads include, but are not limited to, functional materials selected from at least one of a metallic powder, a ceramic powder, graphite powder, graphene powder, diamond powder, carbide powder, suicide powder, nitride powder, oxide powder, graphene, carbon nanofibers, carbon nanotubes and mixtures thereof. In terms of the enhancement particles that could be added to each process in the present invention, the enhancement particles could be graphite powder, diamond powder, carbides, silicides, nitrides, oxides, graphene, carbon nanofibers and carbon nanotubes among others.

The following terms and acronyms used in the Detailed Description are defined below.

The term “Advanced Mirror” is used in the title to refer to a mirror improvement that is not found in the current state of the art.

The term “additive manufacturing” is used interchangeably with 3D printing which stands for three-dimensional printing and refers to processes used to synthesize a three-dimensional object in which successive layers of material are formed under computer control to create an object, such as a mirror blank or a disk.

The acronym “CTE” is used as an abbreviation for co-efficient of thermal expansion and defined as the fractional increase in length per unit rise in temperature.

The terms “figure” “figured” and “figuring” refer to shaping a mirror blank. Figuring is a process of polishing an optical surface to remove imperfections and modifying the surface curvature to achieve the aspherical or parabolic shapes, such as convex, concave and the like, such shaping is needed to form the optical surface desired for a given application.

The term “cured green body” is used herein to refer to a polymer-derived ceramic material of a selected composition of ceramic and binder, that has been sintered in a furnace to produce a strong, dense object that is also referred to herein as a mirror substrate or mirror blank.

The term “gelatinous” is used herein to describe the jelly-like state of partially-cured polymers wherein the pre-ceramic polymeric material can be subsequently fully cured then converted to a ceramic through pyrolysis.

The term “high performance” is used herein to describe mirrors that achieve 98% reflection of visible light (490-690 nm wavelength), mirrors that achieve 99% reflection of IR light (700-1150 nm wavelength), mirrors that have an aerial density of 10 kg/m² or less, mirrors that have a high specific stiffness, and mirrors that have a low co-efficient of thermal expansion (CTE).

The terms “mirror blank” and mirror blank substrate” are used herein interchangeably with “mirror substrate” which means the base for a first-surface mirror wherein the completed mirror is formed by the application of a very thin metallic coating, such as aluminum, gold or silver to provide the mirror function.

The terms “metallizing” or metallized” are used to refer to the addition of a very thin layer of metal.

The term “pristine” is used herein to mean clean, free of soil and grime.

Table 1 below provides examples of Polymer-Derived Ceramic (PDC) systems useful in the present invention. The Table shows both density and specific density ranges allowing the choice of lighter to heavier weight PDCs when forming the mirror substrates. The preferred embodiment of the present invention uses silicon oxycarbide (SiOC) to provide the lighter weighted mirror blank.

TABLE 1

| PDC System | Density Range (g/cc) | Specific Density (g/cc) |
|---|---|---|
| SiOC | 1.7-2.8 | 2.1-2.2 |
| SiCN | 1.85-2.3 | 2.1-2.3 |
| Si—Ti—O—C | 1.9-2.6 | 2.35 |
| Si—Al—O—C | 2.8-3.4 | 3.0-3.1 |
| Si—B—C—N | 1.80-2.3 | 2.1-2.3 |
| BN | 1.8-2.1 | 1.95 |
| Si—Al—O—N | 2.3-3.0 | 2.6 |
| SiC | 3.0-3.3 | 3.05 |

### First Embodiment

### Green Body Figured, Pyrolyzed, PDC Coated, Polished, Metallized

In order to produce the ultimate mirror, the polished surface will be the same polymer-derived ceramic (PDC) composition as the light-weighted PDC mirror blank. This will reduce co-efficient of thermal expansion (CTE) mismatch between the surface coating and the porous mirror substrate blank. Co-efficient of thermal expansion (CTE) mismatch can cause cracking if the CTE mismatch is determined to be approximately 0.5 ppm to approximately 5.0 ppm, depending on the application. It is also possible to use a non-lightweighted mirror blank if weight is not an issue.

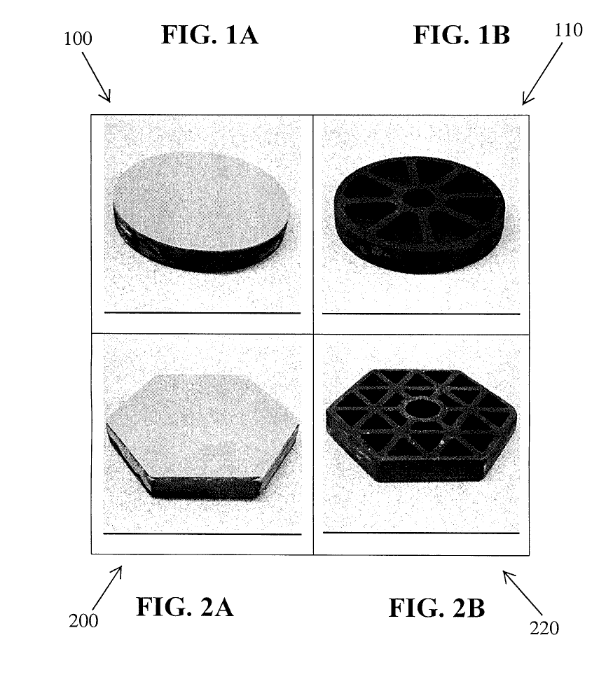

In the first embodiment, the green body is produced by the processes described in U.S. Pat. No. 8,961,840, which is incorporated by reference in its entirety. The porosity of the green body varies between 2% and 98% ceramic porosity, similar to that described by U.S. Pat. No. 8,961,840. The green body is machined to a figure or molded to a figure. A figure being defined as concave, convex, aspherical or other shape optimized for mirror performance. This green body is pyrolyzed to produce SiOC ceramic, for example, or other ceramic. A circular shape is shown in FIG. 1A, front view 100 and FIG. 1B, back view 110. A hexagonal shape is shown in FIG. 2A, front view 200 and FIG. 2B, back view 220.

In addition, a dense, non-porous, viscous layer of PDC resin of approximately 0.5 microns to approximately 350 microns is applied to the surface of the mirror green body then pyrolyzed to a ceramic layer. Then, the fully dense layer of ceramic will be polished to provide a pristine surface. After that the pristine surface will be metallized using aluminum or gold or some other metal such as silver needed to provide the mirror function. Ideally the fully dense PDC coating layer will form a PDC ceramic that is the exact same material as the substrate.

### Second Embodiment

### Ceramic Mirror Blank Figured, Sealed and Coated

The green body is produced by the processes described in U.S. Pat. No. 8,961,840 before being figured. Again, the figure could be produced by a mold or machined into the green body. Also, in this embodiment, the mirror blank could be figured by grinding, lapping, and/or polishing prior to providing a precision figure to the mirror blank. After the pyrolysis process and the green body conversion to a porous ceramic, the porous ceramic mirror blank could be figured by grinding, lapping, and/or polishing if needed. Then, the porous surface of the ceramic mirror blank is sealed and coated. Possible candidates for sealing and coating the porous surface prepared according to the methods disclosed in U.S. Pat. No. 8,961,840 include, but are not limited to, using:
1) Glasses in all of their various compositions and ways of application such as melted borosilicate or a glass ceramic, such as, Zerodur®, registered trademark owned by Schott AG, Mainz, Germany.
2) Polymer resins such as polyimide or polyphenol.
3) Silicon based sol gels derived from TEOS, MTEOS or DEDMS that are dipped, sprayed or cast onto the ceramic mirror blank surface.

TEOS refers to Tetraethyl orthosilicate is the chemical compound with the formula Si(OC₂H₅)₄ and is a precursor for SiO2 films.

MTEOS refers to Methyl Triethoxysilane is an organosilicon compound with the formula CH₃Si(OCH₃)₃ and is a precursor for SiO2 films.

DEDMS refers to Dimethyldiethoxysilane is the chemical compound with the formula C6H16O2Si and is a precursor for SiO2 films.

Recent new formulations of polyimide resins are particularly attractive as pore fillers and coatings because they are highly polishable. In addition, the polyimide resins have a low cure temperature that is between room temperature (approximately 23° C.) to approximately 300° C., and low CTE in a range from approximately −0.50 ppm to approximately 1.0 ppm.

The coatings have to be able to seal the pores in the PDC mirror blank, which is preferably made of silicon oxycarbide (SiOC), as well as, provide a level surface which is smooth and defect free. This surface will receive the metallization layer of aluminum or gold or some other metal such as silver needed to provide the mirror function.

### Third Embodiment

### Infiltration of Porous Ceramic PDC to Form Composites

In a process similar to the second embodiment, a green body is produced, figured before or after pyrolysis to form a mirror blank, the figured, pyrolyzed green body forms a ceramic mirror blank with a porous surface that is then sealed and coated to form a level, smooth, defect free surface that receives the metallization layer needed for the mirror function. The difference in the third embodiment is that metal, glass, polymer, and/or ceramic could be infiltrated as a liquid or slurry into the porous polymer-derived ceramic (PDC) substrate after producing the PDC ceramic but before the sealing and coating material is added. The third embodiment composite, includes, but is not limited to, Metal-PDC, Glass-PDC, Polymer-PDC, Ceramic-PDC or multiple combinations thereof. The metal, glass, polymer, and ceramic particles are added to alter the properties of the porous PDC to make the properties more advantageous to a particular application.

### Fourth Embodiment

### Electromagnetic (EM) Energy Concentrator Mirror

In a process similar to the third embodiment, a green body is produced, figured before or after pyrolysis to form a mirror blank, the figured, pyrolyzed green body forms a ceramic mirror blank with a porous surface.

In the design of electromagnetic (EM) energy concentrators, i.e. radar dishes, radio telescopes or IR (infra red) or visible light telescopes for example, the required reflecting surface quality depends on the wavelength of the EM (electro-magnetic) energy being collected. The longer the wavelength, the larger the tolerable surface imperfections can be. IR and microwave with wavelengths greater than or equal to 0.7 microns in width would be perfect for the fourth embodiment.

In the fourth embodiment the porous ceramic mirror blank would remain unsealed. The pores would remain open, yet narrow enough to reflect IR and microwave wavelengths. The surface would be ground and polished and metallized with the pores still remaining in the surface of the mirror. The pore size can be tailored such that, depending on the wavelength of interest, they are smaller than the wavelength of the EM energy thus the pores would not interfere with the performance of the mirror. In this embodiment, coatings are not needed to provide a reflective mirror surface.

### Fifth Embodiment

### Aspheric Mirror

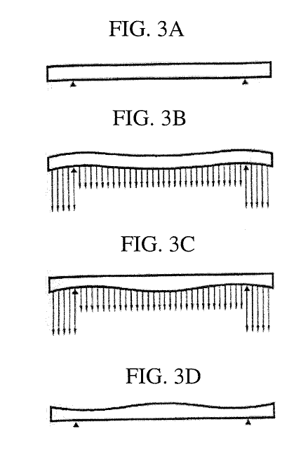

FIGS. 3A, 3B, 3C and 3D are prior art illustrations of how an aspheric mirror or lens is made. FIG. 3A shows a mirror blank positioned wherein all sides of the rectangular block are even and smooth. FIG. 3B shows the initiation of stress polishing wherein there are slight indentations and curvatures of the rectangular block. FIG. 3C shows the continuation of stress polishing wherein one side of the block is curved while the opposing side is straight. FIG. 3D is an inverted view of the final aspheric mirror blank with the mirror or reflective side of the rectangular block showing a well-defined undulating curve while the opposing side is straight.

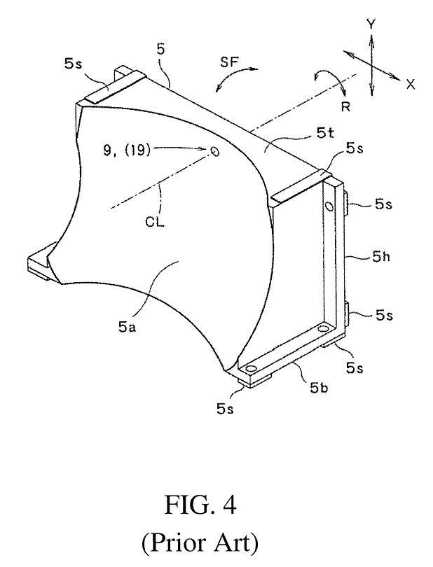

FIG. 4 is taken from U.S. Pat. No. 8,192,032 to Takahashi et al. dated Jun. 5, 2012 and is incorporated herein by reference as a prior art illustration of detail features of an aspheric mirror 5 that can be cut from a lump of metal, for example, a metallic material for injection molding. The mirror 5 can be produced with STAVAX (a registered trademark) that is a stainless tool steel. The STAVAX is plated with NiP (an alloy of nickel and phosphorus) after semi finishing, followed by finishing the reflective mirror surface. NiP plating offers good machinability, good corrosion resistance and higher reflectivity.

As shown in FIG. 4, the aspheric mirror 5 has a concave surface, on the front side that is the reflective surface 5a. The mirror 5 also has a rear surface 5h, the opposite of the reflective surface 5a, a top surface 5t and a bottom surface 5b. Provided on each of the surfaces 5h, 5t and 5b is a highly-precisely-formed supporting surface 5s that is touched with a corresponding member (not shown) in positioning in assembly. The mirror 5 is rotatable about an optical axis CL in directions of R, movable in vertical and horizontal directions X and Y, and tiltable in directions SF, within a specific range in each direction, and mountable in an optimum position or posture. The reflective surface 5a is formed into a mirror, with semi finishing by cutting followed by mirror finishing with lapping. However, the surface 5a can be formed into a mirror in a cutting process with no additional processes. The top and bottom surfaces 5t and 5b are arranged as parallel to each other, with the optical axis CL on the reflective surface 5a, parallel to these surfaces. The reflective surface 5a is a concave surface having the optical axis CL at a non-center position cut away from an aspheric surface symmetrical with respect to the optical axis CL.

A PDC based aspheric mirror is produced in the present invention by filling a mold with partially cured gelatinous beads of PDC resin and placing a lid on the mold that has a surface profile ground and polished into it that is the topographical inverse of the desired aspherical shape. When the mold is pressed closed the shaped surface of the lid would emboss the aspherical shape into the top surface of the PDC bead pack. The mold would then be placed in an oven to cure then the mirror green body would be demolded and placed in a furnace to pyrolize into a ceramic mirror. The ceramic mirror's aspherical surface would be polished to a final figure then coated with a reflective material. Alternatively, the mirror green body could be molded with a flat surface then after demolding or after firing to ceramic, the surface could be machined into the desired aspherical shape followed by polishing and applying a reflective coating. It is also possible to create an aspherical shape by feeding the partially cured gelatinous beads of PDC resin into a computer controlled 3D printer. The aspherical shape is cured then placed in a furnace for pyrolization into a ceramic mirror. Faster, easier, lower cost manufacturing of an aspheric mirror is possible with the present invention.

### Sixth Embodiment

### Magnetic Disk for Data Storage

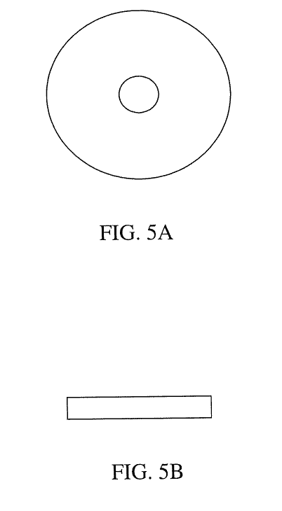

PDC disk drives would be produced by placing partially cured gelatinous beads of PDC resin in a mold and compressing them to the desired thickness and density followed by curing in an oven then demolding and firing to a ceramic in a furnace. After firing, the ceramic disk would be ground flat and coated with the same magnetic material that is used in aluminum or glass based storage disks. FIG. 5A is a top view of a magnetic disk for data storage and FIG. 5B is a side view of a magnetic disk for data storage.

Polymers derived from silicon carbide (SiC) are useful in making ceramic materials that are amorphous, harder than glass, easier to polish and shape, such as, but not limited to, the production of magnetic disk for data storage in computers.

In summary, compared to the prior art, the present invention solves the problem of making strong, durable, light-weight, high performance mirrors and heavy equipment components. The use of partially-cured gelatinous beads of PDC resin to form a green body that is shaped into a mirror blank or disk then pyrolyzed to a ceramic mirror blank or disk results in a dense, crack-free ceramic structure that is easier to polish and shape. More particularly, the present invention provides mirrors suitable for extra-terrestrial space applications, terrestrial applications, and robotic applications with low manufacturing costs. Also, provided herein are PDC/aspheric mirrors for optical devices and PDC/data storage disks for computers. Prior to this invention, polymer-derived ceramic structures were considered too brittle and prone to breaking and were not used in high performance mirror construction and heavy equipment components.

The term “approximately” can be +/−10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A process for producing a mirror using a polymer-derived ceramic (PDC) system, comprising the steps of:
selecting a cured polymer-derived ceramic (PDC) green body;
figuring the cured green body to provide a shaped green body for optimal performance;
applying a dense, non-porous, viscous layer of a PDC resin to the surface of the shaped green body;
pyrolyzing the green body with the dense layer of the PDC resin to form a ceramic mirror blank;
polishing the dense layer of the pyrolyzed PDC resin on the ceramic mirror blank to provide a pristine surface; and
adding a metal layer to the pristine surface of the ceramic mirror blank to provide the mirror function wherein the metal layer is selected from at least one of aluminum, gold, or silver.

2. The process of claim 1, wherein the cured resin green body is formed from a polymer-derived ceramic (PDC) system selected from at least one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) and silicon carbide (SiC).

3. The process of claim 1, where the figuring step includes shaping the cured green body by at least one of machining or molding to create at least one of a concave shape, an aspherical shape, or a convex shape to optimize the mirror performance.

4. The process of claim 1, wherein the dense, non-porous, viscous layer added to the surface of the shaped green body is a PDC resin having a thickness of from approximately 0.5 microns to approximately 350 microns.

5. A process for producing a mirror using a polymer-derived ceramic (PDC) system, comprising the steps of:
selecting a cured resin green body;
shaping the cured green body to optimize mirror performance;
pyrolyzing the shaped green body to form a ceramic mirror blank with a porous surface;
sealing and coating the porous surface of the ceramic mirror blank to provide a smooth, level, defect-free surface; and
adding a metal layer to the smooth, level, defect-free surface of the ceramic mirror blank to provide the mirror function wherein the metal layer is selected from at least one of aluminum, gold, or silver.

6. The process of claim 5, wherein the cured resin green body is formed from a polymer-derived ceramic (PDC) system selected from at least one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) and silicon carbide (SiC).

7. The process of claim 5, wherein the shaping of the green body is performed by at least one of machining, molding, grinding, lapping and polishing to provide a precision figure to the mirror blank.

8. The process of claim 5, wherein the sealing and coating of the porous surface of the mirror blank is provided by adding at least one of glass, polymer resin, or silicon based sol gels to form a smooth, level, defect-free surface.

9. The process of claim 5, further includes the step of adding a plurality of particles selected from metal, glass, polymer, ceramic, and mixtures thereof, to the porous surface of the ceramic mirror blank after pyrolyzing the shaped green body to form a ceramic mirror blank with a porous surface wherein the plurality of particles selected from metal, glass, polymer, ceramic and mixtures thereof form a composite material selected from at least one of a metal-PDC composite, a glass-PDC composite, a polymer-PDC composite, a ceramic-PDC composite or combinations thereof.

10. A process for producing a mirror with a porous surface electromagnetic (EM) concentrator using a polymer-derived ceramic (PDC) system, comprising the steps of:
selecting a cured resin green body;
shaping the cured green body to optimize mirror performance;
pyrolyzing the shaped green body to form a ceramic mirror blank with a porous surface;
adding a plurality of particles selected from metal, glass, polymer, ceramic, and mixtures thereof, to the porous surface of the ceramic mirror blank to alter properties of the porous ceramic mirror blank; and
grinding and polishing the porous surface of the ceramic mirror blank containing the plurality of particles selected from metal, glass, polymer, ceramic, and mixtures thereof of to provide a ground and polished porous surface having pore sizes smaller than the wavelength of the electro-magnetic (EM) energy so that the pore sizes do not interfere with the performance of the mirror in reflecting the EM energy.

11. The process of claim 10, wherein the cured resin green body is formed from a polymer-derived ceramic (PDC) system selected from at least one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) and silicon carbide (SiC).

12. The process of claim 10, wherein the porous surface of the ceramic mirror blank remains unsealed.

13. A process for producing an aspheric mirror using a polymer-derived ceramic (PDC) system, comprising the steps of:
selecting a plurality of partially-cured gelatinous polymer-derived ceramic (PDC) resin beads;
shaping the plurality of partially-cured gelatinous PDC resin beads with a mold having a surface profile that is the topographical inverse of a selected aspheric shape;
placing the mold with the aspheric shaped PDC resin beads into a heating source;
pyrolyzing the aspheric shaped PDC resin beads to form an aspheric ceramic mirror blank;
removing the pyrolyzed aspheric ceramic mirror from the mold;
polishing the aspheric ceramic mirror blank to provide a pristine surface; and
coating the polished aspheric ceramic mirror blank with a reflective material wherein the reflective material is a metal layer selected from at least one of aluminum, gold, or silver.

14. The process of claim 13, further includes shaping the plurality of partially-cured gelatinous PDC resin beads into an aspheric shape using an additive manufacturing process then pyrolyzing the aspheric shaped PDC resin beads to form an aspheric ceramic mirror blank;

15. The process of claim 13, wherein the partially-cured gelatinous PDC resin beads are formed from a polymer-derived ceramic (PDC) system selected from at least one of silicon oxycarbide (SiOC), silicon carbon nitride (SiCN), silicon titanium oxycarbide, (Si—Ti—O—C), silicon aluminum oxycarbide (Si—Al—O—C), boron nitride (BN), silicon-aluminum oxynitride (Si—Al—O—N) and silicon carbide (SiC).

16. A process for producing a mirror substrate for a magnetic data storage disk, comprising the steps of:
selecting a plurality of partially-cured gelatinous polymer-derived ceramic (PDC) resin beads;
placing the plurality of partially-cured gelatinous PDC resin beads in a mold;
compressing the plurality of partially-cured gelatinous PDC resin beads to a thickness of approximately 1 mm to approximately 100 mm;
placing the mold with compressed PDC resin beads into a heating source;
pyrolyzing the plurality of partially-cured PDC resin beads to form a ceramic disk;
removing the pyrolyzed ceramic disk from the mold;
grinding the pyrolyzed ceramic disk to provide a pristine surface; and
coating the ground disk with a magnetic material, wherein the magnetic material is selected from at least one of a cobalt-platinum alloy or an iron-platinum alloy.

17. The process of claim 16, wherein the partially-cured gelatinous PDC resin beads are formed from a polymer-derived ceramic (PDC) system selected from at least one of silicon oxycarbide (SiOC), silicon carbon nitride (SiCN), silicon titanium oxycarbide (Si—Ti—O—C), silicon aluminum oxycarbide (Si—Al—O—C), boron nitride (BN), silicon-aluminum oxynitride (Si—Al—O—N) or silicon carbide (SiC).

18. The process of claim 17, wherein the partially-cured gelatinous PDC resin beads are derived from silicon oxycarbide (SiOC).
